(19) United States
(12) Patent Application Publication
(10) Pub. No.: US 2026/0323106 A1
(43) Pub. Date: Oct. 15, 2026

(54) BROADCAST MONITORING METHOD, BROADCAST MONITORING APPARATUS, SERVER, BROADCAST CONTROL TERMINAL AND INFORMATION DISTRIBUTION SYSTEM

(71) Applicant: BOE TECHNOLOGY GROUP CO., LTD., Beijing (CN)

(72) Inventor: Weiguang GAO, Beijing (CN)

(21) Appl. No.: 19/483,657

(22) PCT Filed: Apr. 17, 2024
(86) PCT No.: PCT/CN2024/088223

§ 371 Date: Nov. 12, 2025

(30) Foreign Application Priority Data
May 31, 2023 (CN) 202310632923.8

(51) Int. Cl. H04N 21/24; H04N 21/262; H04N 21/8352; H04N 21/8358

(52) U.S. Cl. CPC H04N 21/2407; H04N 21/26283; H04N 21/8352; H04N 21/8358

(57) ABSTRACT

The broadcast monitoring method includes: generating a broadcast monitoring identification code of a program according to service information, the service information including broadcast time information of the program, an identifier of a broadcast plan to which the program belongs, a type of the broadcast plan and an identifier of the program; generating a first watermark picture according to the broadcast monitoring identification code; sending a media material of the program and the first watermark picture to a broadcast control terminal, so that the broadcast control terminal controls a display terminal to broadcast the media material with the first watermark picture; receiving a screenshot picture from the broadcast control terminal, the screenshot picture being a picture captured by the broadcast control terminal when the display terminal is broadcasting; and performing broadcast monitoring according to the screenshot picture and the broadcast monitoring identification code.

### CROSS-REFERENCE TO RELATED APPLICATIONS

The present application claims the priority of the Chinese Patent Application No. 202310632923.8 filed on May 31, 2023, the content of which is incorporated herein by reference in its entirety.

### TECHNICAL FIELD

The present disclosure relates to the field of broadcast monitoring technology, and in particular to a broadcast monitoring method, a broadcast monitoring apparatus, a server, a broadcast control terminal, and an information distribution system.

### BACKGROUND

An information distribution system may distribute information to specific people at specific time and place according to business requirements. With the development of the internet, the information distribution system is widely applied in the fields of advertisements, entertainment services and the like.

### SUMMARY OF THE INVENTION

According to an aspect of an embodiment of the present disclosure, there is provided a broadcast monitoring method, including: generating a broadcast monitoring identification code of a program according to service information, wherein the service information includes broadcast time information of the program, an identifier of a broadcast plan to which the program belongs, a type of the broadcast plan and an identifier of the program; generating a first watermark picture according to the broadcast monitoring identification code; sending a media material of the program and the first watermark picture to a broadcast control terminal, so that the broadcast control terminal controls a display terminal to broadcast the media material with the first watermark picture; receiving a screenshot picture from the broadcast control terminal, the screenshot picture being a picture captured by the broadcast control terminal when the display terminal is broadcasting; and performing broadcast monitoring according to the screenshot picture and the broadcast monitoring identification code.

According to another aspect of an embodiment of the present disclosure, there is provided a broadcast monitoring method, including: generating a broadcast monitoring identification code of a program according to service information, wherein the service information includes first information related to the program; generating a first watermark picture according to the broadcast monitoring identification code; sending a media material of the program and the first watermark picture to a broadcast control terminal, to broadcast the media material with the first watermark picture; receiving a screenshot picture from the broadcast control terminal, the screenshot picture being a picture captured when the display terminal is broadcasting; and performing broadcast monitoring according to the screenshot picture and the broadcast monitoring identification code.

In some embodiments, the first information includes an identifier of the program.

In some embodiments, the first information includes sub-information related to a broadcast plan to which the program belongs.

In some embodiments, the sub-information includes at least one of an identifier of the broadcast plan and a type of the broadcast plan.

In some embodiments, the type is one of a normal plan and an interstitial plan.

In some embodiments, the first information includes broadcast time information of the program.

In some embodiments, the broadcast time information of the program includes at least one of a start broadcast time stamp of the broadcast plan to which the program belongs, a start broadcast time stamp of the program, an end broadcast time stamp of the program, and a creation time of the program.

In some embodiments, the type of the broadcast plan to which the program belongs is a normal plan, and the broadcast time information of the program is first broadcast time information; and the type of the broadcast plan to which the program belongs is an interstitial plan, the broadcast time information of the program is second broadcast time information, and the second broadcast time information is different from the first broadcast time information.

In some embodiments, the first broadcast time information includes at least one of the start broadcast time stamp of the broadcast plan to which the program belongs, the start broadcast time stamp of the program, and the end broadcast time stamp of the program; and/or the second broadcast time information includes the creation time of the program.

In some embodiments, the first broadcast time information is the start broadcast time stamp of the broadcast plan to which the program belongs.

In some embodiments, the service information further includes second information related to the broadcast control terminal, and the second information includes identification information of the broadcast control terminal.

In some embodiments, the broadcast monitoring identification code is the service information in the form of a character string.

In some embodiments, the performing broadcast monitoring according to the screenshot picture and the broadcast monitoring identification code includes: parsing a second watermark picture from the screenshot picture; incrementing the number of errors of the broadcast control terminal by one in response that the broadcast monitoring identification code is not acquired according to the second watermark picture; and issuing an alarm in response to the number of errors of the broadcast control terminal being greater than a first preset number.

In some embodiments, the method further includes: storing recording information corresponding to the broadcast monitoring identification code, wherein the recording information includes the broadcast monitoring identification code and an identifier of the program; the performing the broadcast monitoring according to the screenshot picture and the broadcast monitoring identification code further includes: querying the identifier of the program from the recording information corresponding to the broadcast monitoring identification code in response to the broadcast monitoring identification code being acquired according to the second watermark picture; and incrementing the number of errors of the broadcast control terminal by one in response to a current system time of the server being not in a planned broadcast time range of the program.

In some embodiments, performing the broadcast monitoring according to the screenshot picture and the broadcast monitoring identification code further includes: informing the broadcast control terminal to control the display terminal to stop broadcasting in response to the number of errors of the broadcast control terminal being greater than a second preset number, wherein the second preset number is greater than the first preset number.

In some embodiments, the generating the first watermark picture according to the broadcast monitoring identification code includes: encoding the broadcast monitoring identification code to obtain another identification code; and generating the first watermark picture according to the another identification code.

According to still another aspect of an embodiment of the present disclosure, there is provided a broadcast monitoring method, including: receiving a media material of a program and a first watermark picture from a server, wherein the first watermark picture is generated by the server according to a broadcast monitoring identification code, the broadcast monitoring identification code is generated by the server according to service information, and the service information includes one or more of broadcast time information of the program, an identifier of a broadcast plan to which the program belongs, a type of the broadcast plan and an identifier of the program; controlling a display terminal to broadcast the media material with the first watermark picture; acquiring a screenshot picture when the display terminal is broadcasting; and sending the screenshot picture to the server, so that the server performs the broadcast monitoring according to the screenshot picture and the broadcast monitoring identification code.

According to still another aspect of an embodiment of the present disclosure, there is provided a broadcast monitoring method, including: receiving a media material of a program and a first watermark picture from a server; controlling a display terminal to broadcast the media material with the first watermark picture; generating a first broadcast monitoring identification code according to service information, wherein the service information includes one or more of broadcast time information of the program, an identifier of a broadcast plan to which the program belongs, a type of the broadcast plan and an identifier of the program; acquiring a screenshot picture when the display terminal is broadcasting; parsing a second watermark picture from the screenshot picture; acquiring a second broadcast monitoring identification code according to the second watermark picture; and performing broadcast monitoring according to the first broadcast monitoring identification code and the second broadcast monitoring identification code.

In some embodiments, the performing the broadcast monitoring according to the first broadcast monitoring identification code and the second broadcast monitoring identification code includes: incrementing the number of errors of the broadcast control terminal by one in response to the first broadcast monitoring identification code being inconsistent with the second broadcast monitoring identification code; and controlling the display terminal to stop broadcasting in response to the number of errors of the broadcast control terminal being greater than a third preset number.

In some embodiments, the method further includes: controlling the display terminal to stop broadcasting in response to no watermark picture being parsed from the screenshot picture.

According to still another aspect of an embodiment of the present disclosure, there is provided a broadcast monitoring apparatus, including: a memory; and a processor coupled to the memory and configured to perform the method in any one of the above embodiments based on instructions stored in the memory.

According to still another aspect of an embodiment of the present disclosure, there is provided a server including: a memory; and a processor coupled to the memory and configured to perform the method in any one of the above embodiments based on instructions stored in the memory.

According to still another aspect of an embodiment of the present disclosure, there is provided a broadcast control terminal, including: a memory; and a processor coupled to the memory and configured to perform the method in any one of the above embodiments based on instructions stored in the memory.

According to still another aspect of an embodiment of the present disclosure, there is provided an information distribution system including: the broadcast monitoring apparatus in any one of the above embodiments.

According to still another aspect of an embodiment of the present disclosure, there is provided an information distribution system including: the server in any one of the above embodiments and the broadcast control terminal in any one of the above embodiments.

According to still another aspect of an embodiment of the present disclosure, there is provided an information distribution system including: the server configured to perform the broadcast monitoring method in some embodiments; and a broadcast control terminal configured to perform the broadcast monitoring method in some embodiments.

According to still another aspect of an embodiment of the present disclosure, there is provided a computer-readable storage medium including computer program instructions, where the computer program instructions, when executed by a processor, implement the broadcast monitoring method in any one of the above embodiments.

According to still another aspect of an embodiment of the present disclosure, there is provided a computer program product including a computer program, where the computer program, when executed by a processor, implements the broadcast monitoring method in any one of the above embodiments.

Other features, aspects, and advantages of the present disclosure will become apparent from the following detailed description of exemplary embodiments of the present disclosure in connection with the accompanying drawings.

### BRIEF DESCRIPTION OF THE DRAWINGS

The accompanying drawings, which constitute a part of this specification, are for describing the embodiments of the present disclosure, and explaining the principles of the present disclosure together with the description.

The present disclosure may be more clearly understood from the following detailed description taken in conjunction with the accompanying drawings, in which:

FIG. 1 is a schematic view of a structure of an information distribution system according to some embodiments of the present disclosure;

FIG. 2 is a flow chart illustrating a broadcast monitoring method according to some embodiments of the present disclosure;

FIG. 3 is a flow chart illustrating a broadcast monitoring method according to further embodiments of the present disclosure;

FIG. 4 is a flow chart illustrating how to implement broadcast monitoring based on a screenshot picture and a broadcast monitoring identification code;

FIG. 5 is a flow chart illustrating a broadcast monitoring method according to still further embodiments of the present disclosure;

FIG. 6 is a flow chart illustrating a broadcast monitoring method according to still further embodiments of the present disclosure;

FIG. 7 is a flow chart illustrating a broadcast monitoring method according to further embodiments of the present disclosure;

FIG. 8 is a schematic view of a structure of a broadcast monitoring apparatus according to some embodiments of the present disclosure;

FIG. 9 is a schematic view of a structure of a broadcast monitoring apparatus according to further embodiments of the present disclosure;

FIG. 10 is a schematic view of a structure of a broadcast monitoring apparatus according to further embodiments of the present disclosure; and

FIG. 11 is a schematic view of a structure of a broadcast monitoring apparatus according to still further embodiments of the present disclosure.

It should be understood that, like or similar reference numerals refer to like or similar elements.

### DETAIL DESCRIPTION OF THE EMBODIMENTS

Various exemplary embodiments of the present disclosure will now be described in detail with reference to the accompanying drawings. The description of the exemplary embodiments is merely illustrative and is in no way intended to limit the present disclosure, the application, or uses of the present disclosure. The present disclosure may be embodied in many different forms and is not limited to the embodiments described herein. These embodiments are provided so that this disclosure will be thorough and complete, and will fully convey the scope of the present disclosure to a person skilled in the art. It should be noted that: the relative arrangement of parts and steps, the composition of materials, numerical expressions and numerical values set forth in these embodiments are to be construed as merely illustrative, and not restrictive, unless specifically stated otherwise.

The terms “first”, “second”, and the like used in the present disclosure are not intended to indicate any order, quantity, or importance, but rather are used for distinguishing one element from another. The term “comprising”, “including”, or the like means that the element preceding the term contains the element listed after the term, but does not exclude other elements. The terms “upper”, “lower” and the like are used only for indicating relative positional relationships, and when the absolute position of an object being described is changed, the relative positional relationships may also be changed accordingly.

In the present disclosure, when a specific component is described as being located between a first component and a second component, there may or may not be an intervening component between the specific component and the first component or the second component. When the specific component is described as being connected to other components, the specific component may be directly connected to the other components without the intervening component, or may be indirectly connected to the other components with the intervening component.

Unless defined otherwise, all terms (including technical or scientific terms) used herein shall have the ordinary meaning as understood by a person skilled in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Techniques, methods, and devices known to a person skilled in the art may not be discussed in detail but are intended to be part of the specification where appropriate.

The inventor noted that in the related art, there is a stealing broadcast phenomenon in the process of broadcasting the content, but an information distribution system cannot distribute information desired to be distributed according to service requirements due to the lack of a reasonable broadcast monitoring scheme.

In view of this, the embodiments of the present disclosure provide the following solutions.

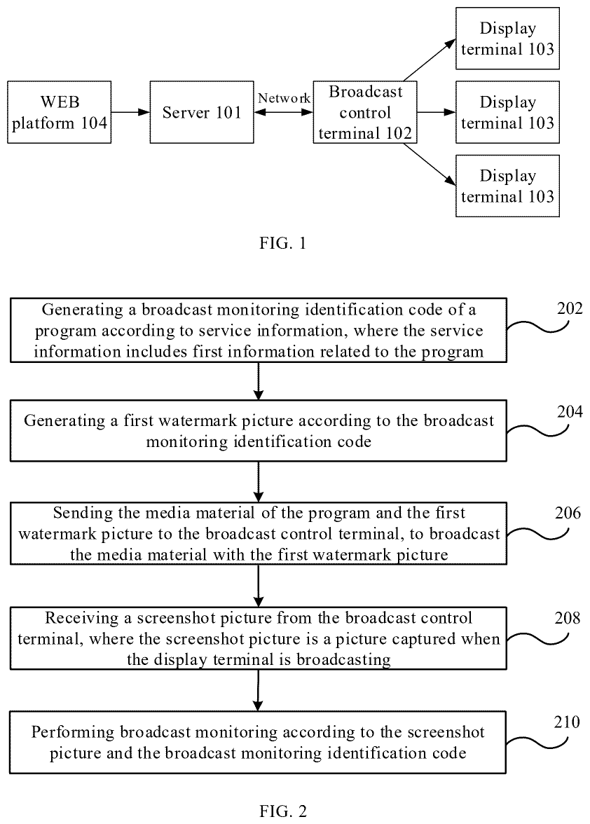

FIG. 1 is a schematic view of a structure of an information distribution system according to some embodiments of the present disclosure.

As shown in FIG. 1, in some embodiments, the information distribution system includes a server 101 and a broadcast control terminal 102. The server 101 interacts with the broadcast control terminal 102 via a network. For example, the network includes a wide area network, a local area network, or a private network. For example, the network includes a wireless network. The server 101 may be a server provided in any one of the following embodiments, and the broadcast control terminal 102 may be a broadcast control terminal provided in any one of the following embodiments.

In other embodiments, the information distribution system further includes one or more display terminals 103, such as a liquid crystal display (LCD) or a light emitting diode (LED) display. In still other embodiments, the information distribution system further includes a world wide web (WEB) platform 104.

An operating process of the information distribution system will be briefly introduced below.

On the WEB platform 104, programming and broadcast plan schedules may be performed based on raw media material (e.g., text, pictures, video, etc.), and the broadcast control terminal 102 may be determined. In response to an issuing request from the WEB platform 104, the server 101 sends the media material of programs (for example, the media material of all programs in a broadcast plan) to the broadcast control terminal 102. The broadcast control terminal 102 controls the corresponding display terminal 104 to broadcast the corresponding program according to predetermined broadcast time.

In order to effectively monitor the broadcasted content of the display terminal 103, in the embodiment of the present disclosure, a code (referred to as a broadcast monitoring identification code or a short code) for broadcast monitoring is generated according to program information, which will be described below in various embodiments.

FIG. 2 is a flow chart illustrating a broadcast monitoring method according to some embodiments of the present disclosure. For example, the broadcast monitoring method may be performed by the server 101.

In step 202, a broadcast monitoring identification code of the program is generated according to service information. Here, the service information includes first information related to the program.

For the sake of convenience of distinction, information related to the program is referred to as the first information. In some embodiments, the first information includes one or more types of information, for example, including at least one of identification information and time information, which will be described below in various embodiments.

In some embodiments, the service information further includes other information, for example, second information related to the broadcast control terminal. As some implementations, the second information includes identification information of the broadcast control terminal.

In some embodiments, the broadcast monitoring identification code is the service information in the form of a character string, that is, the broadcast monitoring identification code is composed of a character string corresponding to each piece of the service information.

In step 204, a first watermark picture is generated according to the broadcast monitoring identification code. For example, the first watermark picture is a transparent watermark picture.

In some embodiments, the broadcast monitoring identification code is encoded to obtain another identification code, and the first watermark picture is generated according to the encoded another identification code. For example, the broadcast monitoring identification code is encoded using an ASCII (American Standard Code for Information Interchange) function to obtain ASCII as another identification code. It should be understood that the embodiments of the present disclosure are not limited thereto, and the broadcast monitoring identification code may alternatively be encoded by using other encoding methods.

In some embodiments, the first watermark picture is generated by using a predetermined watermark algorithm according to the broadcast monitoring identification code and a screen resolution of the display terminal to broadcast the program. Therefore, a resolution of the first watermark picture is consistent with the screen resolution of the display terminal, thereby obtaining the better display effect.

In step 206, the media material of the program and the first watermark picture are sent to the broadcast control terminal, so as to broadcast the media material with the first watermark picture. For example, when the media material is broadcasted, the broadcast control terminal controls to place the first watermark picture at an upper layer for broadcasting.

In some embodiments, the media material of each program in the broadcast plan to which the program belongs is sent to the broadcast control terminal together with the first watermark picture.

In some embodiments, a physical address of the broadcast control terminal, for example a MAC (media access control) address, is determined according to an identifier of the broadcast control terminal, and the media material of the program and the first watermark picture are sent to the broadcast control terminal according to the MAC address.

In step 208, a screenshot picture from the broadcast control terminal is received. Here, the screenshot picture is a picture captured in the process of broadcasting the content by the display terminal. In other words, the screenshot picture is a screenshot picture of the display terminal.

For example, the screenshot picture is captured by the broadcast control terminal; for another example, the screenshot picture is captured by other components and then sent to the broadcast control terminal. In some embodiments, one screenshot picture is captured at predetermined intervals, for example, one minute, two minutes, or the like. In some embodiments, the received screenshot picture is a picture obtained by compressing an acquired initial screenshot picture by the broadcast control terminal.

In step 210, the broadcast monitoring is performed according to the screenshot picture and the broadcast monitoring identification code.

It is understood that in the case of normal broadcasting, the media material with the first watermark picture is broadcasted by the display terminal. Therefore, the first watermark picture in the screenshot picture may be acquired according to the screenshot picture of the display terminal, and then the broadcast monitoring identification code is acquired according to the acquired first watermark picture. Then, it may be determined according to the broadcast monitoring identification code obtained from the screenshot picture and the broadcast monitoring identification code generated in step 204 whether the display terminal normally broadcasts according to the broadcast plan.

In the above embodiment, the broadcast monitoring identification code of the program is generated according to the information related to the program, and the media material of the program and the first watermark picture generated according to the broadcast monitoring identification code are sent to the broadcast control terminal for broadcasting. And then, the broadcast monitoring is performing according to the screenshot picture captured when the display terminal is displaying and the previously generated broadcast monitoring identification code. Because the information related to the program represents the characteristics of the program and changes with different programs, the broadcast monitoring identification code generated according to the information related to the program is not easy to crack. Therefore, the content broadcasted by the display terminal can be accurately monitored by using such the broadcast monitoring identification code.

It can be understood that, in the above manner, respective corresponding broadcast monitoring identification codes may be generated for different programs. For example, for a first program, a first broadcast monitoring identification code corresponding to the first program is generated; and for a second program, a second broadcast monitoring identification code corresponding to the second program is generated. The display terminal may broadcast the first program or the second program during broadcasting. The content broadcasted by the display terminal may be monitored through the screenshot picture captured when the display terminal is broadcasting, the previously generated first broadcast monitoring identification code and the previously generated second broadcast monitoring identification code.

The first information related to the program will be described below in various embodiments.

In some embodiments, the first information related to the program includes one or more of broadcast time information of the program, sub-information related to a broadcast plan to which the program belongs, and an identifier of the program.

Therefore, the broadcast monitoring identification code generated according to the first information is not easy to crack, and the content broadcasted by the display terminal can be monitored more accurately.

As some implementations, the first information includes any one of the broadcast time information of the program, the sub-information related to the broadcast plan to which the program belongs, and the identifier of the program. For example, the first information includes the identifier of the program; for another example, the first information includes the sub-information related to the broadcast plan to which the program belongs; for another example, the first information includes the broadcast time information of the program. In the case that the sub-information related to the broadcast plan to which the program belongs or the broadcast time information of the program is considered, the generated broadcast monitoring identification code is not easy to crack, and therefore the content broadcasted by the display terminal can be monitored more accurately.

As other implementations, the first information includes more (for example two or three) of the broadcast time information of the program, the sub-information related to the broadcast plan to which the program belongs, and the identifier of the program. For example, the first information includes the broadcast time information of the program and the sub-information related to the broadcast plan to which the program belongs; for another example, the first information includes the broadcast time information of the program and the identifier of the program; for another example, the first information includes the sub-information related to the broadcast plan to which the program belongs and the identifier of the program; for example, the first information includes the broadcast time information of the program, the sub-information related to the broadcast plan to which the program belongs, and the identifier of the program.

In the above implementation, the first information includes more of the above types of information. Therefore, the broadcast monitoring identification code generated according to the first information is not easy to crack, and the content broadcasted by the display terminal can be monitored more accurately.

For example, in the case that the first information includes the broadcast time information of the program and the identifier of the program, even if the identifiers of different programs are the same, the generated broadcast monitoring identification codes are different, so that the content broadcasted by the display terminal can be monitored more accurately.

For another example, when the first information includes the broadcast time information of the program and the identifier of the program, the generated broadcast monitoring identification codes are different even if the identifiers of different programs are the same, so that the content broadcasted by the display terminal can be monitored more accurately.

Some embodiments of the sub-information related to the broadcast plan to which the program belongs are described next.

In some embodiments, the sub-information related to the broadcast plan to which the program belongs includes at least one of an identifier of the broadcast plan and a type of the broadcast plan. For example, the sub-information includes both the identifier of the broadcast plan and the type of the broadcast plan, so as to further improve the difficulty in cracking the broadcast monitoring identification code, thereby monitoring the content broadcasted by the display terminal more accurately.

For example, one broadcast plan corresponds to one or more programs. In other words, different programs may belong to the same broadcast plan.

As some implementations, the type of the broadcast plan is one of a normal plan and an interstitial plan. It should be understood that the programs corresponding to the normal plan are broadcasted according to the plan (e.g. according to a planned broadcast time range), and the programs corresponding to the interstitial plan are broadcasted when the programs corresponding to the normal plan are not broadcasted. For example, the programs corresponding to the interstitial plan are broadcasted when the programs corresponding to the normal plan cannot be broadcasted normally.

Some embodiments of the broadcast time information of the program are described next.

In some embodiments, the broadcast time information of the program includes at least one of a start broadcast time stamp of the broadcast plan to which the program belongs, a start broadcast time stamp of the program, an end broadcast time stamp of the program, and a creation time of the program. By considering the time broadcast information, the difficulty of cracking the broadcast monitoring identification code can be further improved, so that the content broadcasted by the display terminal can be monitored more accurately.

As some implementations, the broadcast time information of the program includes any one of the start broadcast time stamp of the broadcast plan to which the program belongs, the start broadcast time stamp of the program, the end broadcast time stamp of the program, and the creation time of the program. For example, the broadcast time information of the program includes the start broadcast time stamp of the broadcast plan to which the program belongs; as another example, the broadcast time information of the program includes the creation time of the program. It should be understood that in the case where each broadcast plan corresponds to the plurality of programs, the start broadcast time stamp of the broadcast plan is the start broadcast time stamp of the program with the earliest start broadcast time stamp of the plurality of programs corresponding to the broadcast plan.

As other implementations, the broadcast time information of the program includes more (for example two, three or four) of the start broadcast time stamp of the broadcast plan to which the program belongs, the start broadcast time stamp of the program, the end broadcast time stamp of the program, and the creation time of the program. Therefore, the difficulty of cracking the broadcast monitoring identification code can be further improved, and the content broadcasted by the display terminal can be monitored more accurately.

In some embodiments, the broadcast time information for the program is related to the type of the broadcast plan to which the program belongs. The following description is made in connection with certain examples.

For convenience of description, hereinafter, in the case where the type of the broadcast plan to which the program belongs is the normal plan, the broadcast time information of the program is referred to as first broadcast time information; and in the case where the broadcast plan to which the program belongs is the interstitial plan, the broadcast time information of the program is referred to as second broadcast time information.

In some embodiments, the second broadcast time information is different from the first broadcast time information. Therefore, for the normal plan and the interstitial plan, the broadcast monitoring identification code is generated according to different broadcast time information, so that the difficulty of cracking the broadcast monitoring identification code can be further improved, and the content broadcasted by the display terminal can be monitored more accurately.

As some implementations, the first broadcast time information includes at least one, e.g., one or more, of the start broadcast time stamp of the broadcast plan to which the program belongs, the start broadcast time stamp of the program, and the end broadcast time stamp of the program. As other implementations, the second broadcast time information includes the creation time of the program. In such a way, the difficulty of cracking the broadcast monitoring identification codes of the programs corresponding to the normal plan or the interstitial plan can be further improved, so that the program content corresponding to the normal plan or the interstitial plan broadcasted by the display terminal can be monitored more accurately.

As still other implementations, the first broadcast time information includes at least one of the start broadcast time stamp of the broadcast plan to which the program belongs, the start broadcast time stamp of the program, and the end broadcast time stamp of the program; and the second broadcast time information includes the creation time of the program. Therefore, the difficulty of cracking the broadcast monitoring identification codes of the programs corresponding to the normal plan and the interstitial plan can be further improved, so that the program content corresponding to the normal plan and the interstitial plan broadcasted by the display terminal can be monitored more accurately.

In some embodiments, the first broadcast time information is the start broadcast time stamp of the broadcast plan to which the program belongs. In this way, when the broadcast plan corresponds to the plurality of programs, and the broadcast monitoring identification code is generated for each program, the respective broadcast time stamp of each program does not need to be searched, and only the start broadcast time stamp of the broadcast plan is needed, so that the error probability in generating the broadcast monitoring identification code is reduced, and the content broadcasted by the display terminal can be monitored more reliably.

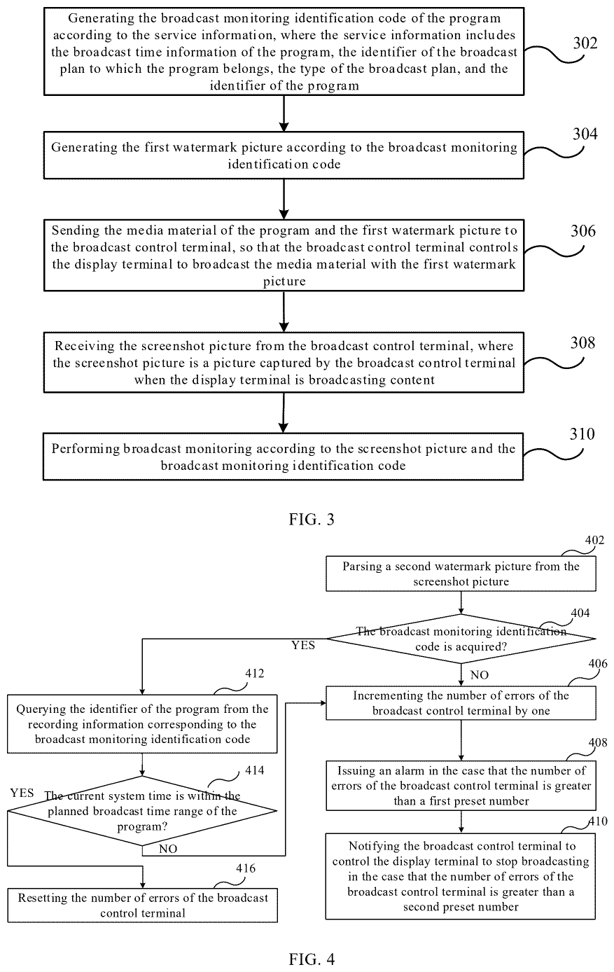

FIG. 3 is a flow chart illustrating a broadcast monitoring method according to further embodiments of the present disclosure. For example, the broadcast monitoring method may be performed by the server 101. The parts in the embodiment shown in FIG. 3 related to the embodiment shown in FIG. 2 may refer to the above description, and the detailed description is omitted here.

In step 302, the broadcast monitoring identification code of the program is generated according to the service information. Here, the service information includes the broadcast time information of the program, the identifier of the broadcast plan to which the program belongs, the type of the broadcast plan, and the identifier of the program.

In some embodiments, the service information further includes an identifier of the broadcast control terminal.

For example, the broadcast monitoring identification code is composed of a character string of the following information: the identifier of the broadcast control terminal, the broadcast time information of the program (for example, the unit is second), the identifier of the broadcast plan to which the program belongs, the type of the broadcast plan, and the identifier of the program. An order of the character strings of different information in the broadcast monitoring identification code is not limited. For example, the character strings may be arranged in the order mentioned above.

In step 304, the first watermark picture is generated according to the broadcast monitoring identification code.

In step 306, the media material of the program and the first watermark picture are sent to the broadcast control terminal, so that the broadcast control terminal controls the display terminal to broadcast the media material with the first watermark picture.

In step 308, the screenshot picture from the broadcast control terminal is received. Here, the screenshot picture is a picture captured by the broadcast control terminal when the display terminal is broadcasting.

In step 310, the broadcast monitoring is performed according to the screenshot picture and the broadcast monitoring identification code.

In the above embodiment, the broadcast monitoring identification code of the program is generated according to the broadcast time information of the program, the identifier of the broadcast plan to which the program belongs, the type of the broadcast plan, and the identifier of the program, and the media material of the program and the first watermark picture generated according to the broadcast monitoring identification code are sent to the broadcast control terminal for broadcasting. And then, the broadcast monitoring is performing according to the screenshot picture captured when the display terminal is displaying and the previously generated broadcast monitoring identification code. The generated broadcast monitoring identification code is not easy to crack. Therefore, the content broadcasted by the display terminal can be monitored more accurately by using such a broadcast monitoring identification code.

The following describes an implementation of performing the broadcast monitoring according to the screenshot picture and the broadcast monitoring identification code in connection with some embodiments.

FIG. 4 is a flow chart illustrating how to perform broadcast monitoring based on a screenshot picture and a broadcast monitoring identification code.

In some embodiments, referring to FIG. 4, the step of performing the broadcast monitoring according to the screenshot picture and the broadcast monitoring identification code includes steps 402, 404, 406 and 408.

In step 402, a second watermark picture is parsed from the screenshot picture.

In some embodiments, after the second watermark picture is parsed, ASCII is acquired from the second watermark picture, and the broadcast monitoring identification code is acquired by using an ASCII inversion function.

In step 404, it is determined whether the broadcast monitoring identification code is acquired according to the second watermark picture.

If not, that is, in the case that the previously generated broadcast monitoring identification code (generated in step 204 or step 304) is not acquired according to the second watermark picture, step 406 is performed.

In step 406, the number of errors of the broadcast control terminal is incremented by one. For example, an initial value of the number of errors of the broadcast control terminal is 0.

Subsequently, it may be determined whether to alarm or not according to the number of errors of the broadcast control terminal.

In step 408, in the case that the number of errors of the broadcast control terminal is greater than a first preset number, an alarm is given. It is understood that the first preset number is equal to or greater than 1. In some embodiments, the WEB platform may prompt for an alarm message.

In the above embodiment, in the case that the previously generated broadcast monitoring identification code is not acquired according to the second watermark picture, the number of errors of the broadcast control terminal is incremented by one. The alarm is given when the number of errors of the broadcast control terminal is greater than the first preset number. Therefore, the wrong alarm caused by the fact that the broadcast monitoring identification code cannot be acquired due to poor quality of the screenshot picture is avoided, and the content broadcasted by the display terminal can be accurately monitored.

In other embodiments, the step of performing the broadcast monitoring according to the screenshot picture and the broadcast monitoring identification code further includes step 410.

In step 410, in the case that the number of errors of the broadcast control terminal is greater than a second preset number, the broadcast control terminal is notified to control the display terminal to stop broadcasting, where the second preset number is greater than the first preset number. For example, the first preset number is 5, and the second preset number is 10.

For example, in the case that the number of errors of the broadcast control terminal is greater than the second preset number, the broadcast control terminal is notified to control the display terminal to close the screen.

In still other embodiments, after the broadcast monitoring identification code is generated, recording information corresponding to the broadcast monitoring identification code is stored, and the recording information includes the broadcast monitoring identification code and the identifier of the program. For example, the recording information is stored in a recording table. In some embodiments, the user may view the recording information; in other embodiments, the user may change the information in the recording information.

The recording information may further include other information. As some implementations, the recording information further includes the identifier of the broadcast control terminal. As other implementations, the recording information further includes one or more of a primary key, the identifier of the broadcast plan to which the program belongs, the type of the broadcast plan, the generation time of the broadcast monitoring identification code, the number of passes of broadcast monitoring verification, and the passing time of the broadcast monitoring verification. As still other implementations, the recording information further includes a note. For example, the information that the alarm is given in step 408, such as the alarm time, may be stored in the note of the recording information; for another example, the information that the broadcast control terminal is notified to control the display terminal to stop broadcasting in step 410, such as the notification time, may be stored in the note of the recording information.

In the case of storing the recording information, referring to FIG. 4, if the judgment result in step 404 is yes, step 412 is performed.

In step 412, the identifier of the program is queried from the recording information corresponding to the broadcast monitoring identification code.

For example, the screenshot picture carries a MAC address of the broadcast control terminal, and the identifier of the broadcast control terminal may be searched according to the MAC address carried by the screenshot picture. In this case, the identifier of the program may be queried from the recording information according to the broadcast monitoring identification code obtained based on the screenshot picture and the searched identifier of the broadcast control terminal, so that the searched identifier of the program is more accurate.

In step 414, it is determined whether the current system time of the server is within the planned broadcast time range of the program. If not, that is, the current system time of the server is not within the planned broadcast time range of the program, the process returns to step 406. In some embodiments, if yes, that is, the current system time of the server is within the planned broadcast time range of the program, step 416 is performed.

In step 416, the number of errors of the broadcast control terminal is reset.

In the above embodiment, when the broadcast monitoring identification code is not acquired according to the second watermark picture, the number of errors of the broadcast control terminal is incremented by one. When the current system time of the server is not in the planned broadcast time range of the program, the number of errors of the broadcast control terminal is incremented by one. Therefore, the content broadcasted by the display terminal can be monitored more effectively.

In some embodiments, the recording information includes the type of the broadcast plan to which the program belongs. In the case where the type is the normal plan, step 412 is performed; and in the case where the type is the interstitial plan, step 412 is not performed. In this way, the processing pressure of the server can be relieved.

The broadcast monitoring method that may be performed by the server is described above with reference to various embodiments, and the broadcast monitoring method that may be performed by the broadcast control terminal is described below with reference to some embodiments.

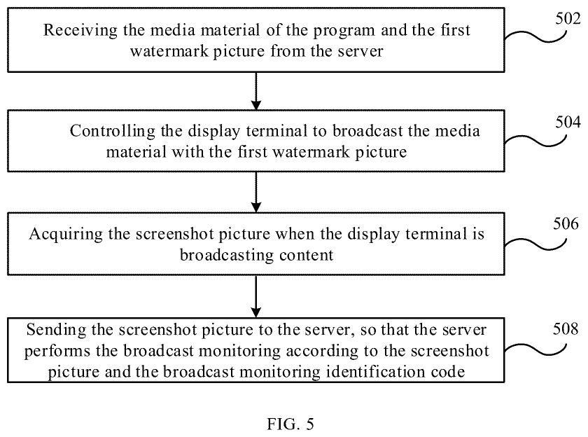

FIG. 5 is a flow chart illustrating a broadcast monitoring method according to still further embodiments of the present disclosure. For example, the broadcast monitoring method may be performed by the broadcast control terminal 102.

In step 502, the media material of the program and the first watermark picture are received from the server. Here, the first watermark picture is generated by the server according to the broadcast monitoring identification code, and the broadcast monitoring identification code is generated by the server according to the service information. The service information includes one or more of the broadcast time information of the program, the identifier of the broadcast plan to which the program belongs, the type of the broadcast plan, and the identifier of the program.

In step 504, the display terminal is controlled to broadcast the media material with the first watermark picture.

In step 506, the screenshot picture is acquired when the display terminal is broadcasting.

It will be appreciated that under normal circumstances, the display terminal broadcasts the media material with the first watermark picture under the control of the broadcast control terminal. If the stealing broadcast phenomenon occurs, the content broadcasted by the display terminal is no longer the content expected to be broadcasted under the control of the broadcast control terminal.

In step 508, the screenshot picture is sent to the server, so that the server may perform the broadcast monitoring according to the screenshot picture and the broadcast monitoring identification code. The server may perform the broadcast monitoring in the manner described above, and details are not described herein.

In the above embodiment, after the media material of the program and the first watermark picture are received from the server, the screenshot picture captured when the display terminal is broadcasting is sent to the server, so that the server performs the broadcast monitoring according to the screenshot picture and the previously generated broadcast monitoring identification code. The broadcast monitoring identification code generated based on one or more of the broadcast time information of the program, the identifier of the broadcast plan to which the program belongs, the type of the broadcast plan and the identifier of the program is not easy to crack. Therefore, the content broadcasted by the display terminal can be accurately monitored.

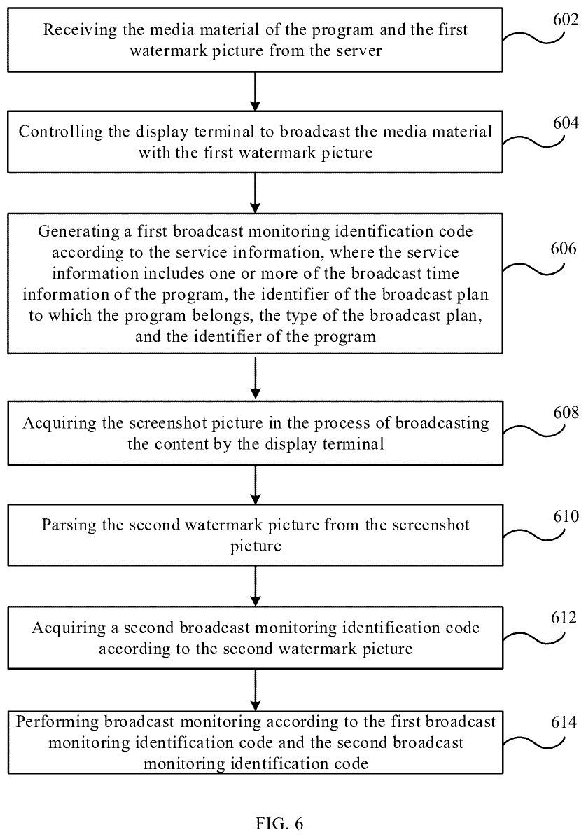

FIG. 6 is a flow chart illustrating a broadcast monitoring method according to still further embodiments of the present disclosure. For example, the broadcast monitoring method may be performed by the broadcast control terminal 102. The parts in the embodiment shown in FIG. 6 related to the embodiment shown in FIG. 5 may refer to the above description, and the detailed description is omitted here.

In step 602, the media material of the program and the first watermark picture are received from the server.

In step 604, the display terminal is controlled to broadcast the media material with the first watermark picture.

In step 606, a first broadcast monitoring identification code is generated according to the service information. Here, the service information includes one or more of the broadcast time information of the program to be broadcasted by the display terminal under the control of the broadcast control terminal according to the plan, the identifier of the broadcast plan to which the program belongs, the type of the broadcast plan, and the identifier of the program.

It can be understood that the broadcast control terminal and the server generate the broadcast monitoring identification code according to the same preset rule. In other words, with the same service information, the broadcast monitoring identification code generated by the broadcast control terminal is the same as the broadcast monitoring identification code generated by the server.

In step 608, the screenshot picture is acquired when the display terminal is broadcasting.

In step 610, the second watermark picture is parsed from the screenshot picture.

In some embodiments, in the case that no watermark picture is parsed from the screenshot picture, the display terminal is controlled to stop broadcasting.

In step 612, a second broadcast monitoring identification code is acquired according to the second watermark picture.

In some embodiments, the display terminal is controlled to stop broadcasting in the case that no watermark picture is acquired according to the second watermark picture.

In step 614, the broadcast monitoring is performed according to the first broadcast monitoring identification code and the second broadcast monitoring identification code.

Some implementations of performing the broadcast monitoring according to the first broadcast monitoring identification code and the second broadcast monitoring identification code are described below.

As some implementations, in the case that the first broadcast monitoring identification code is inconsistent with the second broadcast monitoring identification code, the number of errors of the broadcast control terminal is incremented by one. In the case that the number of errors of the broadcast control terminal is greater than a third preset number, the display terminal is controlled to stop broadcasting, for example, to close a screen.

In the above embodiment, after receiving the media material of the program and the first watermark picture from the server, the broadcast control terminal generates the broadcast monitoring identification code based on one or more of the broadcast time information of the program to be currently broadcasted according to the plan, the identifier of the broadcast plan to which the program belongs, the type of the broadcast plan, and the identifier of the program, and performs the broadcast monitoring according to the screenshot picture and the generated broadcast monitoring identification code. Such the broadcast monitoring identification code is not easy to crack. Therefore, the content broadcasted by the display terminal can be accurately monitored.

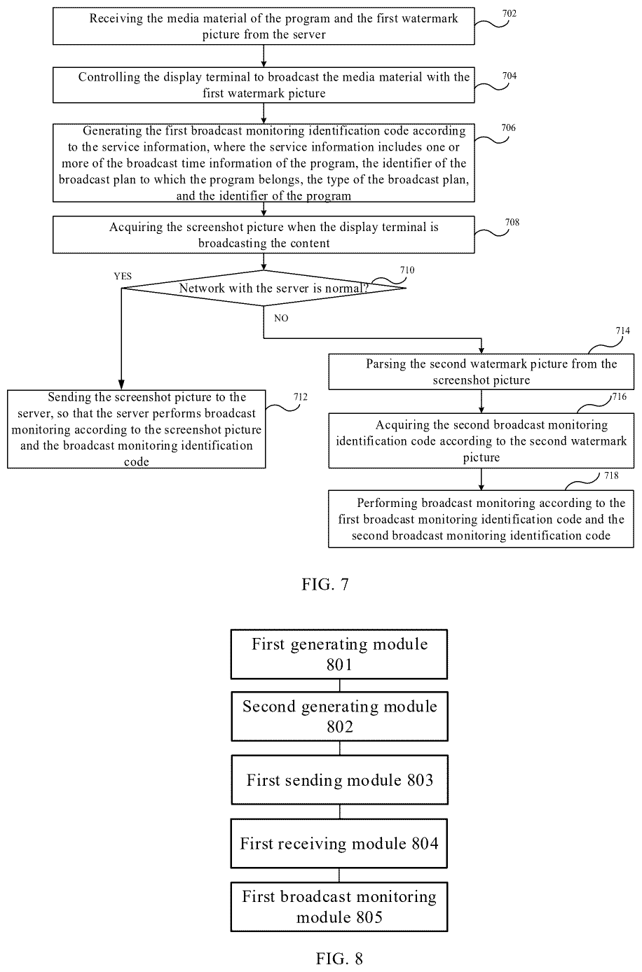

FIG. 7 is a flow chart illustrating a broadcast monitoring method according to further embodiments of the present disclosure. For example, the broadcast monitoring method may be performed by the broadcast control terminal 102. The parts in the embodiment shown in FIG. 7 related to the embodiments shown in FIGS. 5 and 6 may refer to the above description, and the detailed description is omitted here.

In step 702, the media material of the program and the first watermark picture are received from the server.

In step 704, the display terminal is controlled to broadcast the media material with the first watermark picture.

In step 706, the first broadcast monitoring identification code is generated according to the service information. Here, the service information includes one or more of the broadcast time information of the program, the identifier of the broadcast plan to which the program belongs, the type of the broadcast plan, and the identifier of the program.

In step 708, the screenshot picture is acquired when the display terminal is broadcasting.

In step 710, it is determined whether a network with the server is normal. If yes (that is, a network between the broadcast control terminal and the server is not disconnected, that is, the communication is normal), step 712 is performed; if not (that is, the network between the broadcast control terminal and the server is disconnected, that is, the communication is abnormal), steps 714 to 718 are performed.

In step 712, the screenshot picture is sent to the server, so that the server performs the broadcast monitoring according to the screenshot picture and the broadcast monitoring identification code.

In step 714, the second watermark picture is parsed from the screenshot picture.

In step 716, the second broadcast monitoring identification code is acquired according to the second watermark picture.

In step 718, the broadcast monitoring is performed according to the first broadcast monitoring identification code and the second broadcast monitoring identification code.

In the embodiment, in the case that the network between the broadcast control terminal and the server is normal, the server performs the broadcast monitoring according to the screenshot picture and the previously generated broadcast monitoring identification code. In the case that the network between the broadcast control terminal and the server is abnormal, the broadcast control terminal performs the broadcast monitoring according to the broadcast monitoring identification code and the screenshot picture generated by the broadcast control terminal. Therefore, on one hand, with the normal network, the server preferentially performs the broadcast monitoring, and the broadcast control terminal is not required to generate a broadcast monitoring identification code additionally, thereby relieving the pressure of the broadcast control terminal; on the other hand, even if the network is abnormal, the content broadcasted by the display terminal can be accurately monitored.

It should be understood that the different monitoring methods in the above embodiments may be combined with each other to obtain the monitoring method performed by the server and the broadcast control terminal.

In the present specification, the embodiments are described in a progressive manner, and each embodiment focuses on differences from other embodiments, and the same or similar parts in the embodiments refer to each other. An apparatus embodiment basically corresponds to the method embodiment, and therefore, the description for the apparatus embodiment is relatively simple, and for relevant points, reference may be made to the description for the method embodiment.

The embodiment of the present disclosure further provides a broadcast monitoring apparatus, which includes a module configured to perform the broadcast monitoring method in any one of the above embodiments.

FIG. 8 is a schematic view of a structure of a broadcast monitoring apparatus according to some embodiments of the present disclosure.

As shown in FIG. 8, the broadcast monitoring apparatus includes a first generating module 801, a second generating module 802, a first sending module 803, a first receiving module 804, and a first broadcast monitoring module 805.

In some embodiments, the first generating module 801 is configured to generate the broadcast monitoring identification code of the program according to service information, where the service information includes the broadcast time information of the program, the identifier of the broadcast plan to which the program belongs, the type of the broadcast plan, and the identifier of the program; the second generating module 802 is configured to generate the first watermark picture according to the broadcast monitoring identification code; the first sending module 803 is configured to send the media material of the program and the first watermark picture to the broadcast control terminal, so that the broadcast control terminal controls the display terminal to broadcast the media material with the first watermark picture; the first receiving module 804 is configured to receive the screenshot picture from the broadcast control terminal, where the screenshot picture is a picture captured by the broadcast control terminal when the display terminal is broadcasting; and the first broadcast monitoring module 805 is configured to perform the broadcast monitoring according to the screenshot picture and the broadcast monitoring identification code.

In other embodiments, the first generating module 801 is configured to generate the broadcast monitoring identification code of the program according to the service information, where the service information includes the first information related to the program; the second generating module 802 is configured to generate the first watermark picture according to the broadcast monitoring identification code; the first sending module 803 is configured to send the media material of the program and the first watermark picture to the broadcast control terminal, to broadcast the media material with the first watermark picture; the first receiving module 804 is configured to receive the screenshot picture from the broadcast control terminal, where the screenshot picture is a picture captured when the display terminal is broadcasting; and the first broadcast monitoring module 805 is configured to perform the broadcast monitoring according to the screenshot picture and the broadcast monitoring identification code.

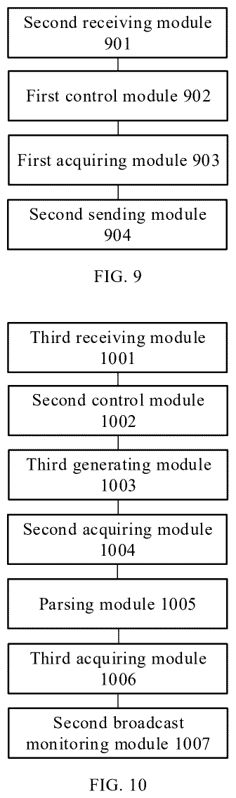

FIG. 9 is a schematic view of a structure of a broadcast monitoring apparatus according to further embodiments of the present disclosure.

As shown in FIG. 9, the broadcast monitoring apparatus includes a second receiving module 901, a first control module 902, a first acquiring module 903, and a second sending module 904.

The second receiving module 901 is configured to receive the media material of the program and the first watermark picture from the server, where the first watermark picture is generated by the server according to the broadcast monitoring identification code, and the broadcast monitoring identification code is generated by the server according to the service information, and the service information includes one or more of the broadcast time information of the program, the identifier of the broadcast plan to which the program belongs, the type of the broadcast plan, and the identifier of the program. The first control module 902 is configured to control the display terminal to broadcast the media material with the first watermark picture. The first acquiring module 903 is configured to acquire the screenshot picture when the display terminal is broadcasting. The second sending module 904 is configured to send the screenshot picture to the server, so that the server performs the broadcast monitoring according to the screenshot picture and the broadcast monitoring identification code.

FIG. 10 is a schematic view of a structure of a broadcast monitoring apparatus according to further embodiments of the present disclosure.

As shown in FIG. 10, the broadcast monitoring apparatus includes a third receiving module 1001, a second control module 1002, a third generating module 1003, a second acquiring module 1004, a parsing module 1005, a third acquiring module 1006, and a second broadcast monitoring module 1007.

The third receiving module 1001 is configured to receive the media material of the program and the first watermark picture from the server. The second control module 1002 is configured to control the display terminal to broadcast the media material with the first watermark picture. The third generating module 1003 is configured to generate the first broadcast monitoring identification code according to the service information, where the service information includes one or more of the broadcast time information of the program, the identifier of the broadcast plan to which the program belongs, the type of the broadcast plan, and the identifier of the program. The second acquiring module 1004 is configured to acquire the screenshot picture when the display terminal is broadcasting. The parsing module 1005 is configured to parse the second watermark picture from the screenshot picture. The third acquiring module 1006 is configured to acquire the second broadcast monitoring identification code according to the second watermark picture. The second broadcast monitoring module 1007 is configured to perform the broadcast monitoring according to the first broadcast monitoring identification code and the second broadcast monitoring identification code.

In some embodiments, the second broadcast monitoring module 1007 is configured to increment the number of errors of the broadcast control terminal by one in the case that the first broadcast monitoring identification code is inconsistent with the second broadcast monitoring identification code. In some embodiments, at least one of the first control module 902 and the second control module 1002 is further configured to control the display terminal to stop broadcasting in the case that the number of errors of the broadcast control terminal is greater than the third preset number.

In some embodiments, at least one of the first control module 902 and the second control module 1002 is further configured to control the display terminal to stop broadcasting in the case that the number of errors of the broadcast control terminal is greater than the third preset number.

In some embodiments, at least one of the first control module 902 and the second control module 1002 is further configured to control the display terminal to stop broadcasting in the case that no watermark picture is parsed from the screenshot picture.

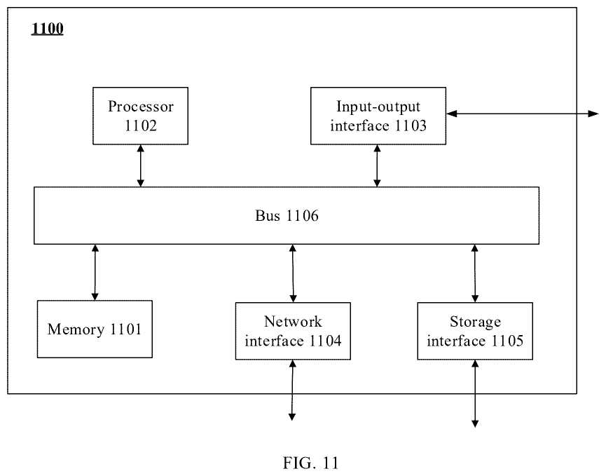

FIG. 11 is a schematic view of a structure of a broadcast monitoring apparatus according to still further embodiments of the present disclosure.

As shown in FIG. 11, the broadcast monitoring apparatus 1100 includes a memory 1101 and a processor 1102 coupled to the memory 1101, and the processor 1102 is configured to perform the broadcast monitoring method in any one of the above embodiments based on instructions stored in the memory 1101.

The memory 1101 may include, for example, a system memory, or a fixed non-volatile storage medium, or the like. The system memory may store, for example, an operating system, application programs, a boot loader and other programs.

In some embodiments, the broadcast monitoring apparatus 1100 may further include an input-output interface 1103, a network interface 1104, a storage interface 1105, and the like. These interfaces 1103, 1104, 1105 and the memory 1101 and the processor 1102 may be connected to each other by a bus 1106, for example. The input-output interface 1103 provides a connection interface for input-output devices such as a display, a mouse, a keyboard, and a touch screen and the like. The network interface 1104 provides a connection interface for various networking devices. The storage interface 1105 provides a connection interface for external storage devices such as an SD card or a USB flash disk or the like.

Some embodiments of the present disclosure provide a server, including: the broadcast monitoring apparatus shown in FIG. 8 or FIG. 11. In some embodiments, the server includes the broadcast monitoring apparatus of other embodiments related to the broadcast monitoring apparatus shown in FIG. 8.

Other embodiments of the present disclosure provide a server, including: a memory; and a processor coupled to the memory and configured to perform the broadcast monitoring method in the embodiments related to any one of FIGS. 1, 2, 3, and 4 based on instructions stored in the memory.

Some embodiments of the present disclosure provide a broadcast control terminal, including: the broadcast monitoring apparatus in the embodiment shown in FIG. 9, FIG. 10 or FIG. 11. In some embodiments, the broadcast control terminal includes the broadcast monitoring apparatus in the other embodiments related to the embodiment shown in FIG. 9 or FIG. 10.

Other embodiments of the present disclosure provide a broadcast control terminal, including: a memory; and a processor coupled to the memory and configured to perform the broadcast monitoring method in the embodiments related to any one of FIGS. 5, 6, and 7 based on instructions stored in the memory.

The information distribution system in some embodiments of the present disclosure includes the broadcast monitoring apparatus in any one of the above embodiments.

The information distribution system according to other embodiments of the present disclosure includes the server and the broadcast control terminal in any one of the above embodiments. In some embodiments, the server is configured to perform the broadcast monitoring method in the embodiments related to any one of FIG. 1, FIG. 2, FIG. 3, and FIG. 4, and the broadcast control terminal is configured to perform the broadcast monitoring method in the embodiments related to any one of FIG. 5, FIG. 6, and FIG. 7.

The embodiment of the present disclosure further provides a computer-readable storage medium, which includes computer program instructions, and the computer program instructions, when are executed by a processor, implement the broadcast monitoring method in any one of the above embodiments.

The embodiments of the present disclosure further provide a computer program product, which includes a computer program, and the computer program, when is executed by a processor, implements the broadcast monitoring method in any one of the above embodiments.

Thus far, various embodiments of the present disclosure have been described in detail. Some details well known in the art have not been described in order to avoid obscuring the concepts of the present disclosure. A person skilled in the art can now fully appreciate how to implement the technical solution disclosed herein, in view of the above description.

As will be appreciated by a person skilled in the art, embodiments of the present disclosure may provide a method, a system, or a computer program product. Accordingly, the present disclosure may take the form of an entirely hardware embodiment, an entirely software embodiment or an embodiment combining software and hardware. Furthermore, the present disclosure may take the form of a computer program product embodied on one or more computer-usable non-transitory storage media (including, but not limited to, disk storage, CD-ROM, optical storage, or the like) having computer-usable program codes embodied therein.

The present disclosure is described with reference to flow charts and/or block diagrams of a method, an apparatus and a computer program product according to embodiments of the present disclosure. It will be understood that, the functions specified in one or more flows in the flow charts and/or one or more blocks in the block diagrams can be implemented by computer program instructions. These computer program instructions may be provided to a processor of a general purpose computer, special purpose computer, embedded processor, or other programmable data processing apparatus to produce a machine, such that the instructions, which are executed via the processor of the computer or other programmable data processing apparatus, create means for implementing the functions specified in one or more flows in the flow charts and/or one or more blocks in the block diagrams.

These computer program instructions may alternatively be stored in a computer-readable memory that can direct a computer or other programmable data processing apparatus to function in a particular manner, such that the instructions stored in the computer-readable memory produce an article of manufacture including instruction means which implement the functions specified in one or more flows in the flow charts and/or one or more blocks in the block diagrams.

These computer program instructions may alternatively be loaded onto a computer or other programmable data processing apparatus to cause a series of operational steps to be performed on the computer or other programmable apparatus to produce a computer implemented process, such that the instructions, which are executed on the computer or other programmable apparatus, provide steps for implementing the functions specified in one or more flows in the flow charts and/or one or more blocks in the block diagrams.

Although some specific embodiments of the present disclosure have been described in detail by way of example, it should be understood by a person skilled in the art that the above examples are for illustration only and are not intended to limit the scope of the present disclosure. It will be understood by a person skilled in the art that changes may be made to the embodiments, or equivalent substitution of certain technical features may be made without departing from the scope and spirit of the present disclosure. The scope of the present disclosure is defined by the appended claims.

1. A broadcast monitoring method, comprising:
generating a broadcast monitoring identification code of a program according to service information, wherein the service information comprises broadcast time information of the program, an identifier of a broadcast plan to which the program belongs, a type of the broadcast plan and an identifier of the program;
generating a first watermark picture according to the broadcast monitoring identification code;
sending a media material of the program and the first watermark picture to a broadcast control terminal, so that the broadcast control terminal controls a display terminal to broadcast the media material with the first watermark picture;
receiving a screenshot picture from the broadcast control terminal, wherein the screenshot picture is a picture captured by the broadcast control terminal when the display panel is broadcasting; and
performing broadcast monitoring according to the screenshot picture and the broadcast monitoring identification code.

2. A broadcast monitoring method, comprising:
generating a broadcast monitoring identification code of a program according to service information, wherein the service information comprises first information related to the program;
generating a first watermark picture according to the broadcast monitoring identification code;
sending a media material of the program and the first watermark picture to a broadcast control terminal, to broadcast the media material with the first watermark picture;
receiving a screenshot picture from the broadcast control terminal, wherein the screenshot picture is a picture captured when the display terminal is broadcasting; and
performing broadcast monitoring according to the screenshot picture and the broadcast monitoring identification code.

3. The method of claim 2, wherein the first information comprises an identifier of the program.

4. The method of claim 2, wherein the first information comprises sub-information related to a broadcast plan to which the program belongs.

5. The method of claim 4, wherein the sub-information comprises at least one of an identifier of the broadcast plan and a type of the broadcast plan.

6. The method of claim 5, wherein the type is one of a normal plan and an interstitial plan.

7. The method of claim 2, wherein the first information comprises broadcast time information of the program.

8. The method of claim 7, wherein the broadcast time information of the program comprises at least one of a start broadcast time stamp of the broadcast plan to which the program belongs, a start broadcast time stamp of the program, an end broadcast time stamp of the program, and a creation time of the program.

9. The method of claim 8, wherein:
the type of the broadcast plan to which the program belongs is a normal plan, and the broadcast time information of the program is first broadcast time information; and
the type of the broadcast plan to which the program belongs is an interstitial plan, the broadcast time information of the program is second broadcast time information, and the second broadcast time information is different from the first broadcast time information.

10. The method of claim 9, wherein:
the first broadcast time information comprises at least one of the start broadcast time stamp of the broadcast plan to which the program belongs, the start broadcast time stamp of the program, and the end broadcast time stamp of the program; and/or
the second broadcast time information comprises the creation time of the program.

11. The method of claim 10, wherein the first broadcast time information is the start broadcast time stamp of the broadcast plan to which the program belongs.

12. The method of claim 2, wherein the service information further comprises second information related to the broadcast control terminal, and the second information comprises identification information of the broadcast control terminal.

13. The method of claim 2, wherein the broadcast monitoring identification code is the service information in a form of a character string.

14. The method of claim 2, wherein the performing broadcast monitoring according to the screenshot picture and the broadcast monitoring identification code comprises:
parsing a second watermark picture from the screenshot picture;
incrementing the number of errors of the broadcast control terminal by one in response that the broadcast monitoring identification code is not acquired according to the second watermark picture; and
issuing an alarm in response to the number of errors of the broadcast control terminal being greater than a first preset number.

15. The method of claim 14, further comprising:
storing recording information corresponding to the broadcast monitoring identification code such that the recording information comprises the broadcast monitoring identification code and an identifier of the program;
the performing broadcast monitoring according to the screenshot picture and the broadcast monitoring identification code further comprises:
querying the identifier of the program from the recording information corresponding to the broadcast monitoring identification code in response to the broadcast monitoring identification code being acquired according to the second watermark picture; and
incrementing the number of errors of the broadcast control terminal by one in response to a current system time of a server being not in a planned broadcast time range of the program.

16. The method of claim 14, wherein the performing broadcast monitoring according to the screenshot picture and the broadcast monitoring identification code further comprises:
informing the broadcast control terminal to control the display terminal to stop broadcasting in response to the number of errors of the broadcast control terminal being greater than a second preset number, wherein the second preset number is greater than the first preset number.

17. The method of claim 2, wherein the generating the first watermark picture according to the broadcast monitoring identification code comprises:
encoding the broadcast monitoring identification code to obtain another identification code; and
generating the first watermark picture according to the another identification code.

18. (canceled)

19. A broadcast monitoring method, comprising:
receiving a media material of a program and a first watermark picture from a server;
controlling a display terminal to broadcast the media material with the first watermark picture;
generating a first broadcast monitoring identification code according to service information, wherein the service information comprises one or more of broadcast time information of the program, an identifier of a broadcast plan to which the program belongs, a type of the broadcast plan and an identifier of the program;
acquiring a screenshot picture when the display terminal is broadcasting;
parsing a second watermark picture from the screenshot picture;
acquiring a second broadcast monitoring identification code according to the second watermark picture; and
performing broadcast monitoring according to the first broadcast monitoring identification code and the second broadcast monitoring identification code.

20. The method of claim 19, wherein the performing broadcast monitoring according to the first broadcast monitoring identification code and the second broadcast monitoring identification code comprises:
incrementing the number of errors of the broadcast control terminal by one in response to the first broadcast monitoring identification code being inconsistent with the second broadcast monitoring identification code; and
controlling the display terminal to stop broadcasting in response to the number of errors of the broadcast control terminal being greater than a third preset number.

21-25. (canceled)

26. A non-transitory computer-readable storage medium, comprising computer program instructions, wherein the computer program instructions, when executed by a processor, implement the method of claim 2.

27. (canceled)
